(19) United States
(12) Patent Application Publication
(10) Pub. No.: US 2024/0384452 A1
(43) Pub. Date: Nov. 21, 2024

(54) FABRIC AND METHODS FOR DESIGNING AND MANUFACTURING FABRIC

(71) Applicant: OPT Industries, Inc., Medford, MA (US)

(72) Inventors: Zongheng Sun, Cambridge, MA (US); Talia Lin Connelly, Somerville, MA (US); Kai-Hong Anthony Chu, Cambridge, MA (US); Jifei Ou, Medford, MA (US)

(73) Assignee: OPT Industries, Inc., Medford, MA (US)

(21) Appl. No.: 18/691,371

(22) PCT Filed: Sep. 12, 2022
(86) PCT No.: PCT/US2022/043227

§ 371 Date: Mar. 12, 2024

Related U.S. Application Data
(60) Provisional application No. 63/243,461, filed on Sep. 13, 2021.

(51) Int. Cl. D04H 1/56; B29C 64/10; B29L 31/00; B33Y 80/00; D04H 1/4382; D04H 1/4391; D04H 1/74

(52) U.S. Cl. CPC D04H 1/56; B33Y 80/00; D04H 1/43835; D04H 1/4391; D04H 1/74; B29C 64/10; B29L 2031/726; D10B 2403/022

(57) ABSTRACT

In an aspect, provided herein are 3D-printed textiles, such as spacer fabrics. The textiles can have structures and properties that are not possible when made using conventional technologies having knitting, weaving, or sewing needles. For example, the textiles described herein can have variable yarn thickness, variable connectivity between sheets, and even sheets that intersect each other. Also provided herein are methods for making such textiles.

### RELATED APPLICATIONS

This application claims priority to pending U.S. Application Ser. No. 63/243,461, filed Sep. 13, 2021, entitled “FABRIC AND METHODS FOR DESIGNING AND MANUFACTURING FABRIC”, which is hereby incorporated by reference in its entirety.

### NOTICE OF MATERIAL SUBJECT TO COPYRIGHT PROTECTION

Portions of the material in this patent document are subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

A textile is a flexible material traditionally made by creating an interlocking network of yarns or threads, which have been produced by spinning raw fibers (e.g., from either natural or synthetic sources) into long and twisted lengths. Textiles can then be formed by weaving, knitting, crocheting, knotting, tatting, felting, bonding, or braiding these yarns together. The words “fabric” and “cloth” are often used herein as synonyms for textile.

Textiles are used in many products including, but not limited to clothes, upholstery, and carpet, as well as a variety of other consumer goods such as shades, flags, tents, nets, car seats, footwear, parachutes, etc. There is a need for new textiles for improved versions of these products as well as new products not previously made from textiles.

### SUMMARY

The present disclosure provides textiles, methods for designing textiles, and methods for manufacturing textiles. The textiles can have geometries that are not previously possible using conventional manufacturing methods (e.g., which typically rely on needles).

In some instances, the textiles are spacer fabrics. Spacer fabrics are a type of 3D textile structure initially developed in the late 20th century as a replacement for toxic, laminated-layer foam. The spacer fabric can be comprised of a separate top and bottom layer, which are held together by a thicker, vertical pile of yarns running through the middle of the fabric. This middle layer, made of a material like monofilament yarn that resists bending, determines the amount of cushioning (i.e., “space”) between the two opposite layers.

The majority of current commercially-produced spacer fabrics are carried out on an electronic machine known as Raschel warp knitting machine, although double-bed circular and weft-knit machines and electronic jacquard looms are also capable of spacer fabric production. Due to their lightweight nature, high air permeability, and compressive properties, warp knit spacer fabrics have many industry uses including activewear apparel, footwear, outdoor and military gear, transportation, interior insulation, medical care, and geotextile filtration and reinforcements.

As described herein, the textiles (e.g., spacer fabrics) can be 3D-printed. Additive manufacturing technology, also known as 3D printing, allows for the manufacture of finished products with complex geometries that are difficult or impossible to make with other technologies. High-resolution stereolithography 3D printing, specifically Digital Light Processing (DLP) printing technology, can allow printing resolutions of less than 100 micrometers (um). High-resolution 3D printing allows one to produce intricate structures to reduce object weight, construct metamaterials, realize biomimicry design or simply achieve aesthetic surface textures.

In an aspect, provided herein is an article comprising a first sheet and a second sheet, where the second sheet is in a substantially planar orientation with respect to the first sheet and interconnected with a plurality of filaments, and where at least one of: (a) a filament has a varied thickness along its length; (b) at least two of the filaments have different thicknesses with respect to each other; (c) at least two of the filaments have different cross-sectional shapes with respect to each other; (d) the filaments are not substantially parallel to each other; (e) the filaments do not take a substantially linear path between the first sheet and the second sheet; (f) the filaments do not contact the sheets at a substantially common set of vertices; (g) and the filaments make a plurality of connections between the first sheet and a common point on the second sheet.

In some embodiments, the article comprises at least two of (a)-(g).

In some embodiments, the article comprises at least three of (a)-(g).

In some embodiments, the article comprises at least four of (a)-(g).

In some embodiments, the article comprises at least five of (a)-(g).

In some embodiments, the article comprises at least six of (a)-(g).

In some embodiments, the article comprises all of (a)-(g).

In some embodiments, a distance between the first sheet and the second sheet is varied.

In some embodiments, a shortest distance between the first sheet and the second sheet is less than 50% of a longest distance between the first sheet and the second sheet.

In some embodiments, the first sheet or the second sheet comprise pores, which pores have a diameter that varies by at least about 4-fold.

In some embodiments, the first sheet or the second sheet have elevations or depressions.

In some embodiments, the article has at least twice as many filaments contacting a first area of the first sheet as a second area of the first sheet, wherein the first area and the second area are substantially the same size.

In another aspect, provided herein is an article comprising at least four sheets, wherein the sheets are substantially parallel to each other and interconnected with a plurality of filaments.

In some embodiments, the sheets are not laminated to each other.

In some embodiments, the sheets are not sewn together.

In some embodiments, a distance between the sheets is varied.

In some embodiments, a shortest distance between a first sheet and a second sheet is less than 50% of a longest distance between the first sheet and the second sheet.

In some embodiments, at least one of the sheets comprise pores, which pores have a diameter that varies by at least about 4-fold.

In some embodiments, at least one of the sheets has elevations or depressions.

In some embodiments, the article has at least twice as many filaments contacting a first area as a second area, wherein the first area and the second area are substantially the same size.

In another aspect, provided herein is an article comprising a first sheet and a second sheet, wherein the first sheet is on a first surface of the article in a first region of the article, the first sheet crosses through the second sheet at an edge of the first region, and the first sheet is on a second surface of the article in a second region adjacent to the first region, wherein the first sheet and the second sheet are interconnected with a plurality of filaments.

In some embodiments, the first sheet crosses through the second sheet a plurality of times.

In some embodiments, the article is substantially planar.

In another aspect, provided herein is a method for producing a textile comprising 3D printing the article as described herein.

In another aspect, provided herein is a method for designing a textile comprising computationally selecting a geometry as described herein.

It should be appreciated that all combinations of the foregoing concepts and additional concepts discussed in greater detail below (provided such concepts are not mutually inconsistent) are contemplated as being part of the inventive subject matter disclosed herein. In particular, all combinations of subject matter within this disclosure are contemplated as being part of the inventive subject matter disclosed herein.

Still other aspects, examples, and advantages of these exemplary aspects and examples, are discussed in detail below. Moreover, it is to be understood that both the foregoing information and the following detailed description are merely illustrative examples of various aspects and examples, and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### FIGURES

FIG. 1 shows an example of a system for printing from the bottom-up through a transparent window.

FIG. 2 shows an example of a system for printing from the top-down.

FIG. 3 shows an example of a system for printing on a pliable substrate, which is suitable for performing the methods and making the articles described herein.

FIG. 4 shows an example of a multi-layered spacer fabric.

FIG. 5 shows an example of variable thickness of the spacer fabrics provided herein.

FIG. 6 shows an example of the variability in diameter and/or cross-sectional shape of the strands of the present disclosure

FIG. 7 shows an example of the variability in path of the strands of the present disclosure.

FIG. 8 shows an example of strands connecting between facing sheets at vertices.

FIG. 9 shows an example of a plurality of strands connected between various vertices on facing sheets of a spacer fabric.

FIG. 10 shows an example of a regular versus irregular design of a sheet of spacer fabric.

FIG. 11 shows an example of a sheet of spacer fabric produced using the methods described herein where the design is varied in the x-y direction.

FIG. 12 shows an example of the variety of arrangements of sheets that can be printed for the spacer fabrics described herein.

FIG. 13 shows an example of a spacer fabric produced by the methods described herein that does not comprise distinct non-intersecting sheets.

### DESCRIPTION

Materials for the additive manufacturing industry, commonly referred as 3D printing, can utilize a multitude of polymerization techniques to create 3D articles with desirable material performance properties for end-use applications.

The use of 3D printing as described herein can expanded the design possibility for textiles (e.g., spacer fabrics), allowing a high degree of customization and control of the performance of the product. The fidelity between digital construction and physical manufacturing enables coupling of individualized simulation and optimization to the product, such as stress pattern mapping, topological optimization and selective material properties. Digitization has also increased productivity and scale up capabilities by removing constraints of conventional manufacturing processes.

The methods described herein can be used with any 3D printing system. The photo-curable resin can be any suitable resin that is capable of polymerization when exposed to radiation (e.g., ultraviolet (UV) radiation). The resin can be part of a formulation that can include a photo-initiator, a UV absorber, a pigment, a diluent, and one or more monomers or oligomers. In some cases, UV radiation interacts with the photo-initiator to start a free-radical mediated polymerization of the monomers and/or oligomers.

Traditionally, UV curable formulations used for additive manufacturing can include ethylenically (i.e., double bond) unsaturated oligomers and monomers (e.g., acrylates, methacrylates, vinyl ethers), diluents, photo-initiators, and additives. The oligomers and monomers can provide mechanical properties to the final product upon polymerization. Diluents can reduce overall formulation viscosity for ease of processing and handling. Diluents can be reactive and can be incorporated into the polymer matrix of the finished article. Photo-initiators can form free radicals upon exposure to actinic radiation (e.g., through photolytic degradation of the photo-initiator molecule). The free radicals can then utilize the ethylenically unsaturated chemical groups to form vinyl-based polymers. Additives can include but are not limited to pigments, dyes, UV absorbers, hindered amine light stabilizers, and fillers. Additives can be used to impart useful properties such as color, shelf stability, improved lifetime performance, higher UV stability, etc.

Following polymerization, the printed article can be removed from the vat of photo-curable resin and washed of residual (non-polymerized) resin. Further processing steps can include additional curing of the printed resin or performing a secondary polymerization.

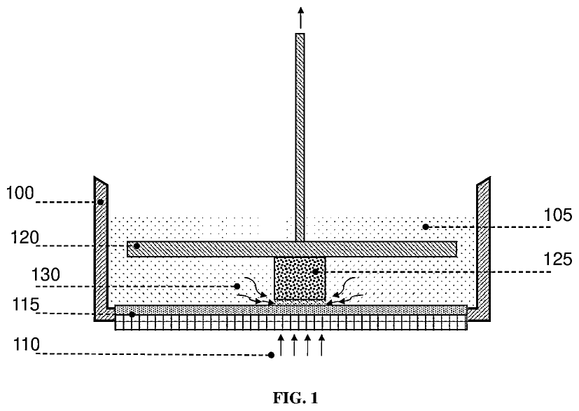

The methods described herein can be performed with any suitable 3D printing hardware (e.g., having digital light processors). FIGS. 1-3 show systems for 3D printing.

As seen in FIG. 1, printing can be performed from the bottom-up through a transparent window. Here, a container 100 can include a volume of photo-curable resin 105. UV light 110 can be projected through a glass plate or lens 115 onto a building platform 120. This can initiate polymerization into a cured article 125. The building platform can be moved upward, which can cause non-cured resin to flow and recoat 130 the printed article with resin such that a subsequent layer of the article can be printed.

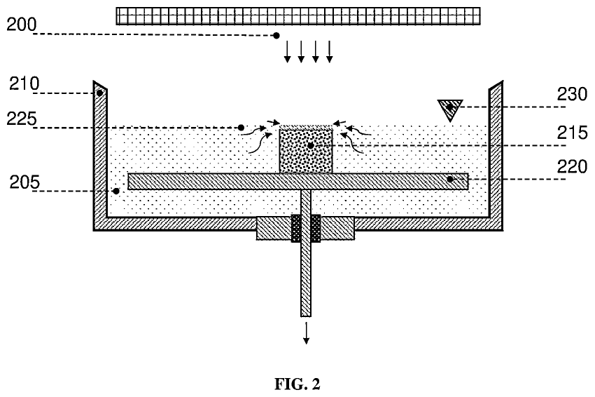

Similarly, FIG. 2 shows an example of a system for printing from the top-down. UV light 200 can be projected from the top-down onto an open surface of photocurable resin 205 that is contained in a vat 210. The cured article 215 can be printed onto a building platform 220 which can be moved downward into the vat of resin after each print layer. This can result in un-cured resin flowing 225 onto the surface of the cured article, which can be subsequently exposed to radiation to print another layer of the printed article. In some instances, this re-flow of resin is a rate limiting step of the overall process. Therefore, a recoating mechanism 230 (e.g., mechanical arm) can assist the recoating process.

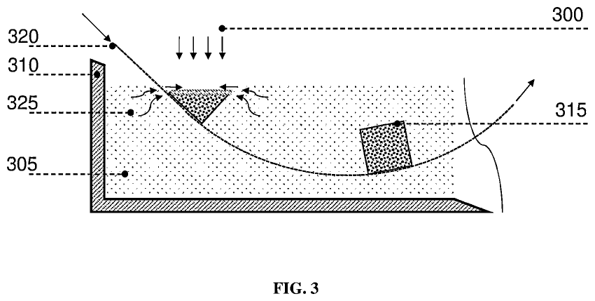

One potential limitation of the top-down and bottom-up systems described herein thus far is that they require resetting the print stage after each article is printed and are not continuous processes. In contrast, FIG. 3 shows an example of a system for printing on a pliable substrate. Here, the pliable substrate can be moved through a vat of the photo-curable resin in a continuous manner while article(s) are printed onto the substrate. UV radiation 300 can be projected onto a surface of a volume of photo-curable resin 305 in a container 310 that is exposed to air. The printed article 315 can be printed onto a pliable substrate 320 that is moved through the photo-curable resin. In some cases, if the printing is continuous, a recoating mechanism is not used and recoating 325 proceeds without mechanical assistance. A suitable system for printing on a pliable substrate is described in U.S. patent application Ser. No. 17/668,503, which is incorporated herein by reference in its entirety. In some cases, printing continuously on a pliable substrate is preferred for the creation of textiles.

The 3D printing systems described above can be used to print a variety of textiles. The shape of the textile and its properties, such as the resolution of fine features, the consistency and extent of cure of the resin can be determined by the combination of many factors such as the mechanical attributes of the system, the chemical attributes of the resin, and the printing methodology. In an aspect, the present disclosure relates to the printing methodology which can include how the printer is operated (e.g., printing speed, continuously or in discrete print layers) and the location and intensity of projected radiation over time.

One printing methodology is to computationally “slice” a model of the 3D object to be printed into a series of layers that nominally constitute the 3D object when printed in succession. This process can be referred to as “rasterization” and printing of “rasterization data”. Further details about the digitization of a design and operation of a 3D printer suitable for production of the textiles described herein can be found in PCT Patent Application Serial No. PCT/US2021/023962, which is incorporated herein in its entirety for all purposes.

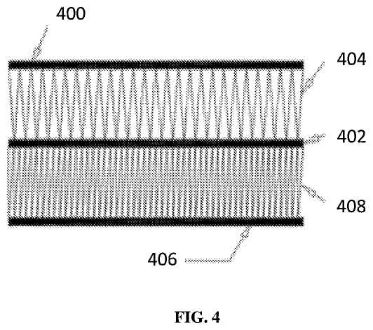

Spacer fabrics are a unique category of textiles because they utilize a multilayered construction, often with distinct performance functions assigned to each layer, see, e.g., FIG. 4. Here, a first knitted layer 400 can be connected to a second knitted layer 402 using a monofilament 404 forming the first spaces space. The second knitted layer 402 can be connected to the third knitted layer 406 using a second monofilament 408 forming a second spaces space. However, industrial warp and weft knitting machines that create spacer fabrics have a number of physical constraints that place limits the fabric's design and functional properties. With current commercial knitting machinery, the maximum number of layers that can be constructed is only three. Traditional manufacturers sometimes laminate multiple spacer fabrics together to increase thickness for more cushioning and support. However, the fabrics run the risk of delaminating or becoming too bulky to sew smoothly, thus limiting construction possibilities. In some instances, provided herein are spacer fabrics with 4, 5, 6, 7, 8, 9, 10, 11, 12, 13, 14, 15, 20, 25, 30, 50, or more layers.

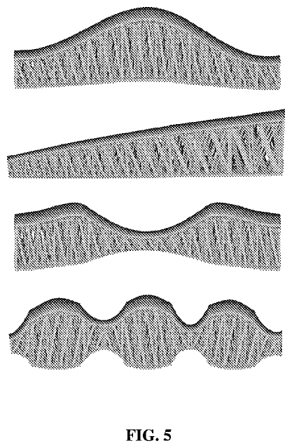

Also, due to a fixed distance between the front and back needle beds using conventional technology, the thickness (or “z” direction) of a commercially-available spacer fabric measures between about 2-10 mm. Variations in a fabric's thickness can serve a decorative purpose, however for spacer fabrics it is key for achieving compression and insulation properties. In contrast, the fabrics provided herein can zonally increase the thickness or reduce unwanted bulk beyond the traditional limit, as seen in FIG. 5. In some embodiments, the spacer fabric thickness is at least about 1 millimeter (mm), at least about 2 mm, at least about 4 mm, at least about 6 mm, at least about 8 mm, at least about 10 mm, at least about 15 mm, at least about 20 mm, at least about 30 mm, at least about 50 mm, at least about 100 mm, at least about 200 mm, or at least about 300 mm. In some cases, the fabric provided herein has a thickness at its thinnest point that is less than the thickness at its thickness point by at least about 10%, at least about 10%, at least about 20%, at least about 30%, at least about 40%, at least about 50%, at least about 60%, at least about 70%, at least about 80%, or at least about 90%.

Using conventional technology, due to the complexity of needle transfers to create a spacer fabric's lofted middle layer, the top and bottom layers must be knitted using only one needle bed in a flat structure such as plain jersey knit. For applications like sound acoustics, a three-dimensional surface would be more applicable. However, structures like ottomans, laces, and rib knits that rely on tuck or transfer stitches to create textural “relief-like” surfaces would require an extra bed of needles, thus limiting the range of elevations or depressions in the spacer's surface. In contrast, the spacer fabrics provided herein can have a three-dimensional surface, e.g., having elevations, gaps, and/or depressions.

Also, using conventional technology, the fixed sizes of the machine's knitting needles can also severely limit the size and variation of yarn that can be used on that specific machine. Commercially-spun yarn typically comes in ranges measuring 0.05 mm to 25 mm in diameter. Each yarn size requires factories to invest in a separate machine with a needle size that corresponds to the yarn's diameter. This yarn-to-machine inflexibility impacts the fabric's density and loop size, leading to broken yarn, jammed machines, and mis-aligned tension in the fabric structure if not continuously monitored and adjusted. In contrast, the methods described herein can use variable “yarn” thicknesses, which are variable within a single textile, or varied between production runs of a single 3D printing machine.

Furthermore, increases in color or pattern complexity increases knitting time using current technology, thus slowing down production. This can cause a sacrifice of design novelty for price and efficiency. In contrast, the methods provided herein can allow users to treat novelty and price as independent factors (e.g., due to a relatively constant manufacturing speed for all designs).

With the option of zonally increasing or decreasing any numbers of layers and thicknesses, and adjusting the density and yarns within a single fabric process, the spacer provided herein fabrics can outperform the functions and designs of traditional counterparts.

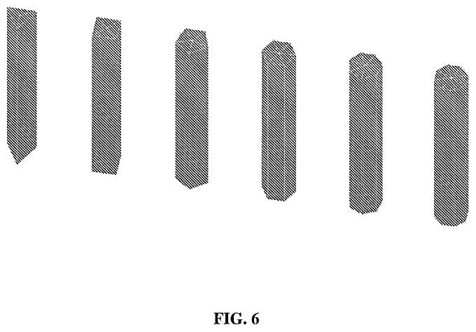

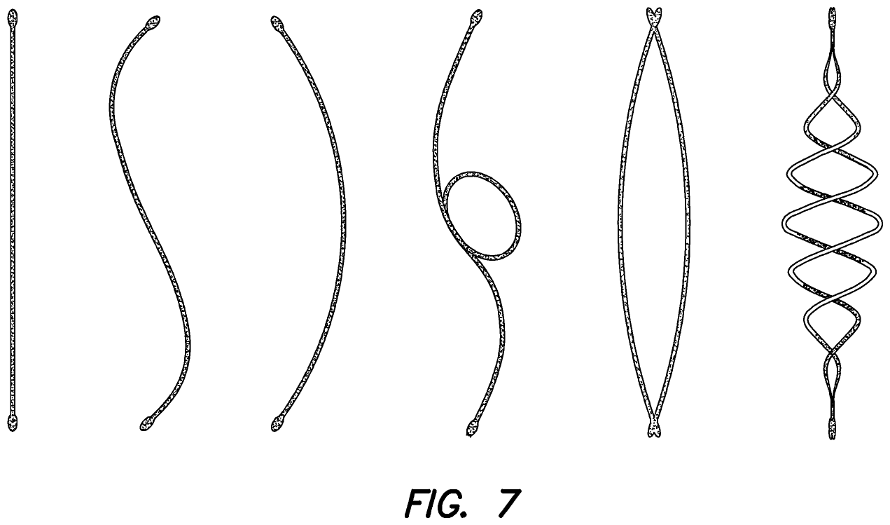

Using the methods described herein, nearly every design constraint for the production of spacer fabrics can be obviated. With reference to FIG. 6, the cross-sectional geometry of the strands can be varied (e.g., within a single strand or between strands). A cross section of a strand, or a portion thereof, can be circular, elliptical, triangular, trapezoidal, square, or a polygon having 5, 6, 7, 8, 9, 10, or more sides. The diameter of a strand can also vary within the strand or between strands. Furthermore, with reference to FIG. 7, the path of the strands (also referred to herein interchangeably as threads or filaments) can be varied from straight, to any curved or non-straight path.

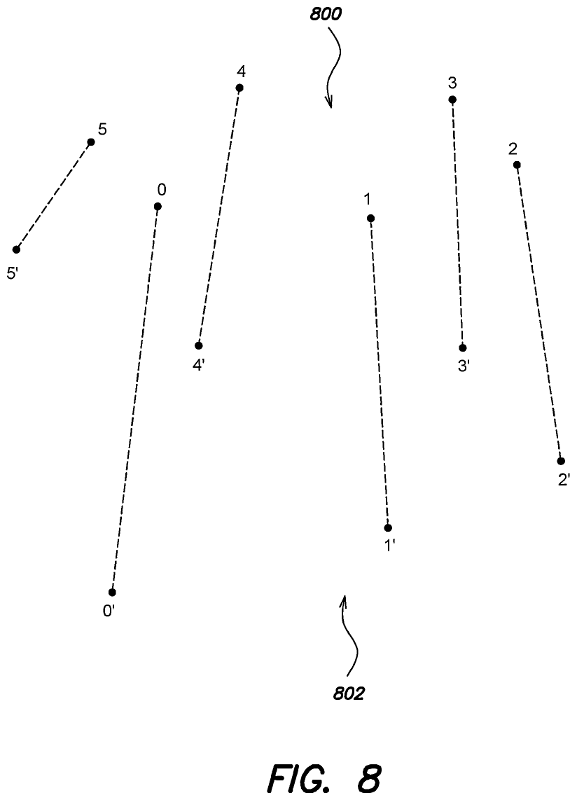

The endpoints of the strands can also be varied. As shown in FIG. 8, no single continuous strand makes all of the connections between parallel sheets. Here, the sheets are omitted from the drawing for clarity but are substantially parallel to each other with a first sheet 800 on the top (coming into contact with the numbered ends of the strands) and a second sheet 802 on the bottom (coming into contact with the prime numbered ends of the strands). For each strand, a first end is connected to a first sheet and a second end (designated by a number having a prime, i.e., apostrophe) is connected to a second sheet facing the first sheet. The locations of the vertices do not need to coincide (i.e., each strand can be an independent entity).

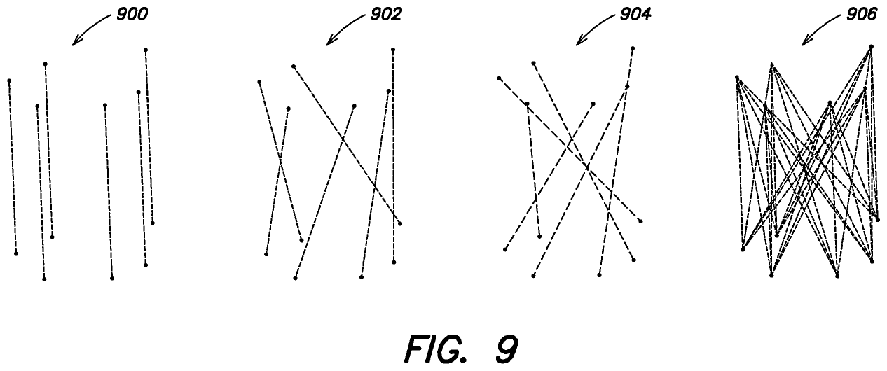

FIG. 9 shows that vertices on a first sheet can be connected to a plurality of vertices on a second sheet, i.e., in any combination. The strands can be substantially parallel 900, substantially not parallel 902, have a relatively low amount of connectivity between the sheets 904, or have a relatively high level of connectivity between the sheets 906.

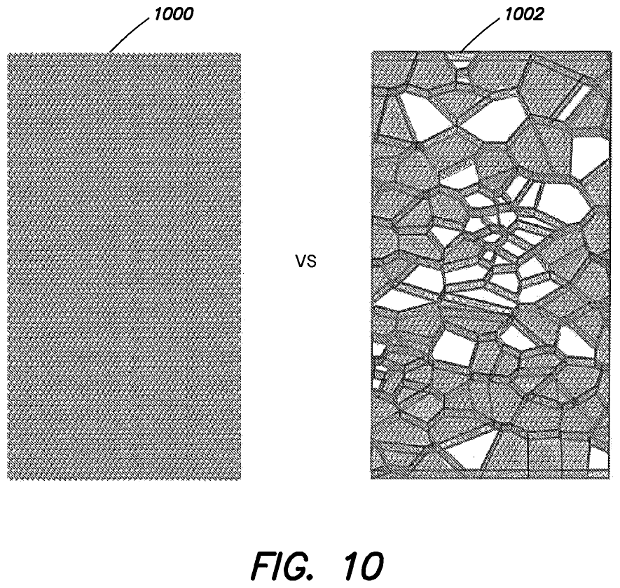

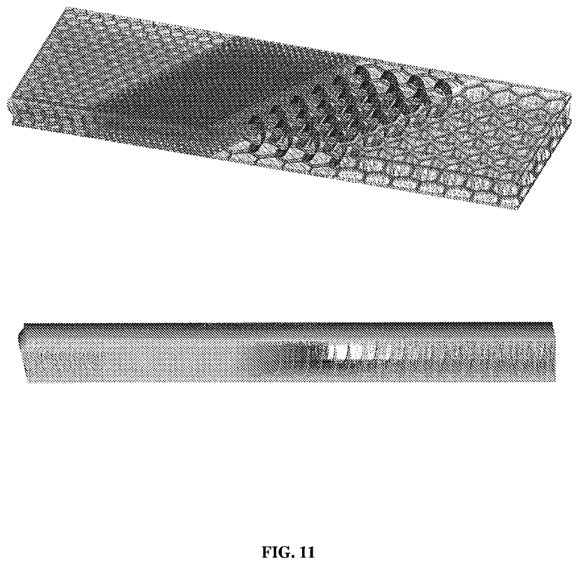

The sheets themselves can also be varied in any suitable way. FIG. 10 shows a top-down view of an example of a sheet produced using conventional technology 1000 that has a regular pattern, while the sheet produced using the 3D printing methods described herein 1002 can have any (i.e., an irregular) pattern. The design of the sheet can also be varied in the x-y direction, in some cases seamlessly (i.e., without a discontinuity), for example, as shown in FIG. 11.

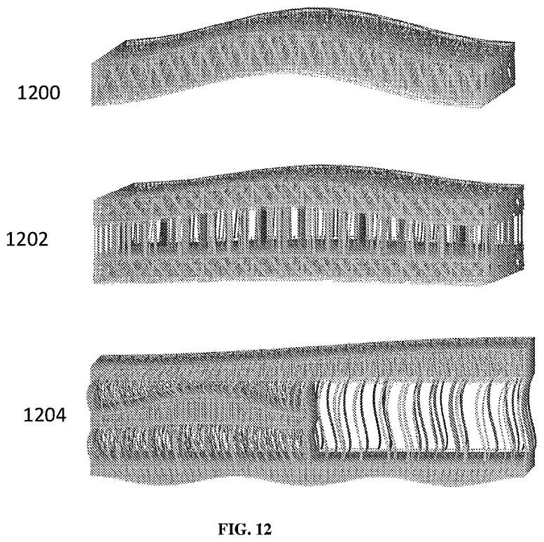

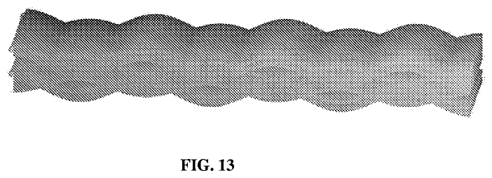

Furthermore, the number and arrangement of the sheets can be varied in the spacer fabric, including within a single printed area of fabric. FIG. 12 shows that the sheets do not have to be substantially planar 1200, do not have to be substantially parallel 1202, and can even have a partially interspersed sheet 1204. The sheets can also intersect each other, as shown in FIG. 13.

The materials and methods described herein can overcome the mechanical and length scale constraints of conventional knitting machines. For example, 3D printers have no fixed number of needle beds, while conventional machinery uses only one or two beds. This means that conventionally, knits can only be made using 1, 2 or 3 layers. However, more beds require more fabric layers. In contrast, the methods described herein can make multilayer fabrics on one machine, all at the same time.

The methods described herein have no fixed number of needles on each bed while conventional machinery is usually built with “predetermined widths”.

The methods described herein have no fixed needle “heights”. In contrast, conventionally, a bed of needles are all going to be the same height, so resulting fabric's width (i.e., thickness) is uniformly straight. However, here, spacers can have varying thicknesses (bubble, wave, dome, etc.) to accommodate for variable compression needs.

The methods described herein have no fixed pitch of the needle. In contrast, conventionally, all needles are attached to the needle bed on the same “plane”/angle, and all face the same direction.

The methods described herein have no fixed width between needles. In contrast, conventional needles are evenly spaced between each other, so spacing between the knitted stitches will be uniformly tensioned/stretchable. However, here, spacers can have variable gaps between each knitted stitch, to accommodate for variable elasticity needs.

The methods described herein have no fixed needle gauge or “size”. In contrast, conventional needle sizes run from gauge 3-4 (chunky knit) to gauge 40-42 (super fine), which means the size of knit has to remain roughly the same for all fabrics produced on that machine.

The methods described herein have no constraint on “yarn” size. Conventionally, the needle gauge constrains the type of yarn that a designer can use on the machine. For example, a gauge 40 needle needs a gauge 40 yarn or smaller. Conventionally, it can be hard to run course handspun yarn through a gauge 40 machine, for example. Furthermore, the yarn cannot knit and the machine will become jammed if this is attempted using conventional methods. In contrast, here, spacers can have different textures and different-sized yarn diameters in a very specific area of the product. In some cases, one can engineer the hand-feel and the stretch of the product.

The methods described herein have no fixed number of “yarn cones” (most commercial machines only have 6 yarn feeders total, and the more “cones” you add to the feeders, the slower the machine will knit). The material described herein can print at the same speed and can hold as many “yarn cones” as a designer wants to use. This can give a textile designer the ability to make as many textures and as they want in their product (e.g., fluffy yarn, smooth yarn, thin yarn, thick yarn, slubbed yarn, coiled yarn, etc.).

The methods described herein can be orientation agnostic. For example, the same design can be produced in any orientation, such as not confined to 90 degree vertical (warp knitting machine) or 180 degree horizontal (weft knitting machine). For example, the methods described herein can “knit” on a 45-degree angle, or combine different degrees to give new patterns.

In some cases, a digital seam to reduce or remove the assembly time.

In some embodiments, the textile can be made to the cutting pattern to reduce waste. The article can be made “fully fashioned” (i.e., completely assembled right off the machine) so there's no need to knit separate pieces.

Also, it should be appreciated that one or more 3D printing systems may be used to implement the one or more systems, methods and file formats to 3D print such microstructures. For example, some embodiments may be used in conjunction with one or more systems described in U.S. patent application Ser. No. 17/668,503, which is incorporated herein by reference in its entirety. However, it should be appreciated that other printer methods and systems may be used with embodiments as described herein.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware or with one or more processors programmed using microcode or software to perform the functions recited above.

In this respect, it should be appreciated that one implementation of the embodiments of the present invention comprises at least one non-transitory computer-readable storage medium (e.g., a computer memory, a portable memory, a compact disk, etc.) encoded with a computer program (i.e., a plurality of instructions), which, when executed on a processor, performs the above-discussed functions of the embodiments of the present invention. The computer-readable storage medium can be transportable such that the program stored thereon can be loaded onto any computer resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

Various aspects of the present invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments of the invention may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

1. An article comprising a first sheet and a second sheet, wherein the second sheet is in a substantially planar orientation with respect to the first sheet and interconnected with a plurality of filaments, wherein at least one of:
a. a filament has a varied thickness along its length;
b. at least two of the filaments have different thicknesses with respect to each other;
c. at least two of the filaments have different cross-sectional shapes with respect to each other;
d. the filaments are not substantially parallel to each other;
e. the filaments do not take a substantially linear path between the first sheet and the second sheet;
f. the filaments do not contact the sheets at a substantially common set of vertices; and
g. the filaments make a plurality of connections between the first sheet and a common point on the second sheet.

2. The article of claim 1, wherein the article comprises at least two of (a)-(g).

3. The article of claim 1, wherein the article comprises at least three of (a)-(g).

4. The article of claim 1, wherein the article comprises at least four of (a)-(g).

5.-7. (canceled)

8. The article of claim 1, wherein a distance between the first sheet and the second sheet is varied.

9. The article of claim 1, wherein a shortest distance between the first sheet and the second sheet is less than 50% of a longest distance between the first sheet and the second sheet.

10. The article of claim 1, wherein the first sheet or the second sheet comprise pores, which pores have a diameter that varies by at least about 4-fold.

11. The article of claim 1, wherein the first sheet or the second sheet have elevations or depressions.

12. The article of claim 1, wherein the article has at least twice as many filaments contacting a first area of the first sheet as a second area of the first sheet, wherein the first area and the second area are substantially the same size.

13. An article comprising at least four sheets, wherein the sheets are substantially parallel to each other and interconnected with a plurality of filaments.

14. The article of claim 13, wherein the sheets are not laminated to each other.

15. The article of claim 13, wherein the sheets are not sewn together.

16. The article of claim 13, wherein a filament has a varied thickness along its length.

17. The article of claim 13, wherein at least two of the filaments have different thicknesses with respect to each other.

18. The article of claim 13, wherein at least two of the filaments have different cross-sectional shapes with respect to each other.

19.-21. (canceled)

22. The article of claim 13, wherein the filaments make a plurality of connections between the first sheet and a common point on the second sheet.

23. (canceled)

24. The article of claim 13, wherein a shortest distance between a first sheet and a second sheet is less than 50% of a longest distance between the first sheet and the second sheet.

25. The article of claim 13, wherein at least one of the sheets comprise pores, which pores have a diameter that varies by at least about 4-fold.

26. The article of claim 13, wherein at least one of the sheets has elevations or depressions.

27. (canceled)

28. An article comprising a first sheet and a second sheet, wherein the first sheet is on a first surface of the article in a first region of the article, the first sheet crosses through the second sheet at an edge of the first region, and the first sheet is on a second surface of the article in a second region adjacent to the first region, wherein the first sheet and the second sheet are interconnected with a plurality of filaments.

29.-39. (canceled)
